(19) United States
(12) Patent Application Publication
(10) Pub. No.: US 2008/0070308 A1
(43) Pub. Date: Mar. 20, 2008

(54) Portous Article For Delivering Chemical Substances

(76) Inventors: Thomas Ruhland, Roskilde (DK); Per Holm, Vanlose (DK)

Correspondence Address: MORGAN LEWIS & BOCKIUS LLP, 1111 PENNSYLVANIA AVENUE NW, WASHINGTON, DC, 20004, US

(21) Appl. No.: 11/597,786

(22) PCT Filed: Jun. 27, 2005
(86) PCT No.: PCT/DK05/00428

§ 371 Date: Aug. 8, 2007

(30) Foreign Application Priority Data
Jun. 28, 2004 (DK) PA 2004 01011
Mar. 16, 2005 (DK) PA 2005 00378

(51) Int. Cl. G01N 37/00

(52) U.S. Cl. 436/8

(57) ABSTRACT

A reagent delivering article capable of retaining liquid reagents, a method of pre-paring said articles and the use of said articles for loading liquid reagents is provided. Furthermore a reagent delivering article loaded with at least one liquid reagent, a method of preparing same and the use of said loaded article in solution phase chemistry, where said loaded reagent is released from said article into the solution is provided.

### FIELD OF THE INVENTION

The present invention relates to a reagent delivering article, preferably in the form of a tablet. Thus present invention relates to reagent delivering articles capable of retaining liquid or solid reagents, a method of preparing said articles and the use of said articles for loading liquid reagents. In a second aspect, the present invention relates to reagent delivering articles loaded with at least one chemical reagent, a method of preparing same and the use of said loaded articles in solution phase chemistry, where said loaded reagent is released from said articles into the solution.

### BACKGROUND FOR THE INVENTION

Synthetic as well as analytical chemistry may involve numerous process steps comprising addition of chemicals especially within parallel synthesis or mix and split synthesis in the organic chemical field, e.g. combinatorial chemistry and medicinal chemistry.

Parallel syntheses have become important tools in the search for new compounds in e.g. the pharmaceutical industry and material sciences. Using these concepts, a large number of compounds are synthesized. Parallel synthesis is a particular form of organisation of chemical syntheses where a large number of chemical syntheses are performed separately at the same time in order to obtain a large number of new single compounds, typically for research purposes. Parallel synthesis can, for example, be used to generate a large number, often hundreds or more, of analogues of a particular molecule in order to determine which analogue has the most desirable activity in a specific assay.

Combinatorial chemistry is a form of parallel synthesis, where the order and the features of the individual steps are performed using a particular combinatorial approach.

In order to carry out parallel synthesis, a large number of additions and separations of substances are necessary.

In certain parallel syntheses, where a large number of reactions are performed simultaneously, the time consumed by the individual dispersing, pipetting or weighing out and distributing the required reagents is considerable. Furthermore errors and mistakes inevitably occur during the required large number of individual dispersing, pipetting or weighing. Additionally, reagents may be hygroscopic or oxygen sensitive and thus require special measures, especially during weighing, which are additionally time consuming and may confer additional inaccuracy, e.g. due to partially degradation or conversion of the reagents.

Further, contact with the reagents may involve a health risk to the staff performing the syntheses.

Thus, there is a need for simple dosing means as an alternative to the dispersing, pipetting or weighing out and distribution of reagents hitherto used in parallel synthesis and split and mix synthesis in order to reduce the time consumption and increase the through-put of the synthesis; decrease the health risk for the personnel and protect the reagents against the deteriorating effect of oxygen and moisture.

Many different dosing forms, tablets for delivering reagents and the like are known for avoiding some of the above problems.

WO 01/68599 describes a process for the manufacture of a dosing form wherein at least one solid active substance is embedded in a polymer matrix shaped as tablets. WO 01/68598 describes dosing forms for delivering functionalized polystyrene resins. When introduced in the synthesis medium, the tablets disintegrate and release the reagents or functionalized resin.

From WO 00/21658 a porous device is known. Said porous device is usable in solid support synthesis. The porous device comprises an active material, which is entrapped within the porous core. Said entrapped material remains entrapped in the device when placed in a solvent.

It should be noted that the use of tablets as dosing form for different types of sub-stances is conventional within other technical areas. Thus, in the pharmaceutical industries, drugs for oral administration are compressed into tablets, usually together with various extenders and adjuvants. These tablets as well as tablets produced in other industries, such as detergent tablets, are intended for disintegration and at least partial dissolution in an aqueous environment, and are not at all intended for non-disintegration.

Reagent delivery systems in the form of porous articles for solution phase chemistry, from which liquid reagent is released when placing the system in a solvent, are, on the other hand, not known.

It is therefore an object of the present invention to address the above problems for reactions to be carried out in solution phase chemistry.

### SUMMARY OF THE INVENTION

Thus, in one aspect the present invention provides a reagent delivering article consisting essentially of a porous material, an optional process aiding substance and an optional solid active substance, which reagent delivering article is capable of retaining at least one liquid reagent.

In a preferred embodiment the reagent delivering article does not comprise a solid active substance.

Preferably, the reagent delivering article remains essentially in the original form and does not substantially disintegrate in solution.

The article of the invention capable of retaining at least one liquid or solid reagent is particularly useful in solution phase chemistry. Upon addition to a solution of the article the reagent(s) is (are) released therefrom; thus, there is provided a predetermined fixed amount of reagent to a reaction mixture.

Large amounts of the inventive article can conveniently be prefabricated. Said article can readily be distributed as such or be loaded automatically with predetermined amounts of different reagents commonly used in the field of chemistry. This provides for a simple distribution of reagents, reduces exposure to hazardous substances, improves dosing precision and accuracy, and the articles are furthermore easy to implement in reactions, makes it possible to speed up the execution of syntheses, in particular synthesis of compound libraries and series, and reduces the complexity of synthesis operations (manual and automated).

In terms of the liquid or solid reagent, being retained in the article of the invention minimizes problems with handling statically charged reagents and increases the stability of functional groups.

All of the above advantages of the article of the invention constitute a time- and cost-efficient means of conducting chemical synthesis in solution.

In another aspect of the invention is provided a method for preparing said reagent delivering article; the method comprises (i) providing a porous material; (ii) optionally mixing the porous material with one or more process aiding substances; (iii) optionally mixing the porous material and the optional process aiding substance(s) with a solid active sub-stance (iv) processing the admixture into a reagent delivering article using conventional technology; and (v) optionally purifying the reagent delivering article.

In particular, the invention relates to the use of a reagent delivering article that can retain at least one liquid reagent that is inert in respect of the porous material and the process aiding substance(s).

In a third aspect of the invention is provided a reagent delivering article consisting essentially of a porous material, optionally a process aiding substance and optionally a solid active substance further comprising at least one liquid reagent, which reagent is inert in respect of the porous material and the optional process aiding substance. Furthermore the reagent delivering article is substantially insoluble in organic and inorganic solvents.

In a fourth aspect of the invention is provided a method for preparing said reagent delivering article; the method comprises (i) providing a porous material; (ii) optionally mixing the porous material with one or more process aiding substances; (iii) optionally mixing the porous material and the optional tabletting aiding substance(s) with a solid active substance (iv) processing the admixture into a reagent delivering article using conventional technology; (v) optionally purifying the reagent delivering article and (vi) loading the reagent delivering article with at least one liquid reagent, which liquid reagent is essentially inert in respect of the porous material and the process aiding substance(s).

In a preferred embodiment the processing of the admixture in step (iv) is a compression of the mixture into tablets using conventional tabletting technology and the process aiding substances is tabletting aiding substances as will be known to the skilled person from the pharmaceutical field.

In particular, the invention relates to reagent delivering articles for use in solution phase chemistry, whereby the retained liquid reagent(s) is released from the said article, particularly for use in parallel solution phase chemistry.

### DESCRIPTION OF FIGURES

FIG. 1 is a graph showing the absorption profile of five compounds; experiments were conducted as outlined in example 2.1.

FIG. 2 is a graph showing the release profile of iodoanisole in four different solvents; experiments were conducted as outlined in example 2.2.

### DETAILED DESCRIPTION OF THE INVENTION

Reagent Delivering Articles

The invention is based on the recognition that reagents contained in a solid porous material may readily be released into a solvent, and therefore may reagents be provided to a reaction medium in an inert porous material. Said inert porous material is according to the invention provided as a reagent delivering article having a predetermined shape and size and forms thereby a novel reagent delivering system for chemical reagents.

The reagent delivering article of the invention is an article capable of retaining liquid or solid reagents and subsequently releasing the reagent(s) in a solution and thus can be seen as a porous reagent delivering article, device or system. The article and different embodiments thereof will now be described in detail below, including methods of preparing the article and use thereof.

The term “chemical reagent” should in this application be understood in the usual way i.e. a compound or mixture of compounds that may take part in and be consumed in a chemical reaction.

By “liquid reagent” as used herein is meant any organic, inorganic, hydrophobic or hydrophilic liquid and any solid or liquid substance dissolved or dispersed in an organic, inorganic, hydrophobic or hydrophilic liquid. The liquid reagent may be a neat compound or a mixture of two or more compounds. It should be understood that the term liquid reagent includes not only compounds that are liquid at ambient temperature, but includes also reagents that are liquid only at higher or lower temperature.

By “retaining” as used here in respect of the article is meant that it is capable of holding within a defined amount of a reagent depending on the origin of the porous material.

The term “solid active substance” is according to the present invention intended to mean a substance having a function in a particular intended chemical reaction. Thus solid chemical active substances may for example be selected from the group containing solid reagents, metals, catalysts or scavengers, and will generally not include compounds having known pharmaceutical activities unless such compounds additionally may be used as reagents, catalysts or scavengers in a particular reaction.

In a preferred embodiment of the invention the reagent delivering article remains essentially in the original form and does not substantially disintegrate when placed in reaction medium.

The term reaction medium is in the present specification intended to be understood in the usual meaning i.e. usually consisting of one or more solvents, reagents, pH adjusting components scavengers etc.

By “remains essentially in the original form” and “does not substantially disintegrate” when placed in reaction medium is meant that the weight of the reagent delivering article after a certain period of time in reaction medium has been reduced by <40% (w/w), preferably <30% (w/w), more preferred <20% (w/w), even more preferred <10% (w/w) and most preferred <5% (w/w). The time for which the reagent delivering article will “remain essentially in the original form and does not substantially disintegrate” or in other words, the stability of the reagent delivering article should be adequate for securing that the reagent delivering article does not substantially disintegrate during the time course of the intended reaction.

By “substantially insoluble” in respect of the porous article is meant that it does not readily dissolve in a solvent so as to contaminate a possible reaction. More particularly, it means that, excluding the chemical reagent, no more than 10% by weight of the reagent delivering article, preferably no more than 5% by weight, more preferably no more than 2% by weight, even more preferably no more than 1% by weight, even more preferred no more that 0.5% by weight, and in a particular preferred embodiment no more than 0.1% by weight of the reagent delivering article may dissolve in solution. In contrast the reagent contained in the article will readily and preferably in almost quantitative amounts be released into the reaction medium.

When it is no longer desired to have the article in a solution, the property of the reagent delivering article that it remains essentially in the original form makes the article of the invention easy to remove and/or discard, either because it does not block a filter process or because the article can simply be removed, in virtue of it being intact, without any filtering.

By only being a preferred embodiment that the reagent delivering article according to the invention is “remaining essentially in the original form and does not substantially disintegrate” situations where the article disintegrate are not excluded. The non-disintegrating feature may be of less importance in, for example but not limited to, situations where only small reagent delivering articles are used and thus no filter problems arise, or if the product of a reaction is distilled off and the remains of the solution are discarded, or if the reaction in question is intended to inactivate a potential hazardous chemical before disposal thereof etc. It is within the skill of the art to recognize the less importance of non-disintegration in particular reactions.

The reagent delivering article of the invention preferably has a predetermined shape. The shape may be in any form, for example but not limited to, a sphere, ellipsoid, a tablet or the like. The shape of the article is not limiting of the function of the article to retain liquid reagents but is a means of varying the article in order to adapt to storage and packaging of the article, convenience in production and use in different reaction vessels having different shapes and dimensions. Furthermore the reagent delivering article may be adapted to a specific tool such as a dispenser for dispensing the reagent delivering article.

The reagent delivering article of the invention may preferably be in the form of a sphere, ellipsoid, tablet, bar cylinder.

The reagent delivering article may be provided with a string in order to ease addition and removal of the device, similar to the principle known from teabags. Other known measures for easy removal of the device from a solution e.g. tweezers, inclusion of a magnetic material for magnetic removal; are also contemplated.

Packaging of the loaded reagent delivering articles in e.g. blister packs is further contemplated. In addition to being a convenient package form blister packs protect the reagent delivering articles against mechanical impact, moisture oxygen etc. and will further protect users thereof against the reagent loaded in the articles, e.g. against fumes of volatile reagents. Such blister packs may even be designed to allow simultaneous dispensing of all articles in a blister pack into an array of reaction tubes or wells, such as a microtiterplate.

In still another preferred embodiment any of the articles prepared according to the invention is provided with an identification means for identifying the articles comprising different reagents (solid and/or liquid) from one another.

The identification means may for example comprise numbers, letters, symbols or colours in a coded combination, bar-codes, chemical structures marked or printed punched card formats, ultraviolet-readable devices or any other readable device such as magnetic strips. The identification means may be provided by radiolabelling or the Irori labelling technology or by any convenient labelling technology known to the skilled person.

It is within the skills of the average practitioner to provide said identification means in the articles according to the invention.

Preparation of the Empty Articles According to the Invention

In one preferred embodiment of the invention the articles are first prepared in an empty form i.e. without a chemical reagent.

Thus, in another aspect of the invention there is provided a method for preparing said empty reagent delivering article; the method comprises (i) providing of a porous material; (ii) optionally mixing the porous material with one or more process aiding substances; (iii) optionally mixing the porous material and the optional process aiding substance(s) with a solid active substance (iv) processing the admixture into a reagent delivering article using conventional technology; and (v) optionally purifying the reagent delivering article.

The steps of mixing the porous material and the optional process aiding substance and the optional solid active substance can be done in any conventional way known by the skilled person in the art.

Similarly, the processing of the porous material, the optional process aiding substance(s) and the optional solid active substance can be carried out by conventional techniques known in the art for preparation of articles having defined uniform shape and size, such as compression, extrusion, pouring, casting, moulding, solidification of a premixture etc.

The process aiding substances according to the invention is any compound having a function in facilitating the mixture of the ingredients, in processing the mixture into reagent delivering articles or in the prepared articles. The skilled person will appreciate that such process aiding substances known for their function in the relevant process technology may be used according to the present invention. Thus, if the reagent delivering articles are prepared using extrusion, process aiding substances known within the extrusion technology may be used, if the reagent delivering articles are prepared using tablet compressing technology is used any tabletting aiding substance used within the pharmaceutical area may be used etc.

A preferred technique for procession of the mixture comprising the porous material is compressing into tablets using conventional tabletting technology and equipment, and the process aiding substance is a tabletting aiding substance more preferred a lubricant.

The porous material to be used in the present invention is any porous material, which is able to retain liquids in any form (organic, inorganic, hydrophilic, hydrophobic, viscous, non-viscous etc.) without any substantial interaction between porous material and the retained liquid, where the liquid upon placement of the material in any solution is able to be released from said porous material into the solution, either instantaneously or continuously.

Also contemplated within the term “porous material” are materials that first obtain the porous character after the processing or after a subsequent additional step; for example but not limited to any material that after an extrusion become porous or any material that first becomes porous after a heat treatment, which subsequent additional step conveniently may take place after the formation of the empty reagent delivering article.

The porous material to be used in the present invention is a porous material, which is substantially inert towards the environment in which it is to be contained in, e.g. atmospheric air or a solution (organic or inorganic); that is said material does not react and/or interact substantially with a solvent in which it is to be used nor reacts and/or interacts substantially with the surrounding environment upon storage of the prepared reagent delivering article. The porous material may be an inorganic material, which is substantially insoluble in inorganic or organic liquids or mixtures thereof.

As examples of suitable porous materials can be mentioned metal oxides, metal silicates, metal carbonates, metal phosphonates and metal sulfates. Further examples of porous materials for use according to the invention are magnesium oxide, calcium oxide, zinc oxide, aluminium oxide, titanium oxide, silicium dioxides including Aerosil, Cab-O-Sil. Syloid, Porasil, Lichrosorp, Aeroperl, Sunsil, Zeofree, Sopernat, swelling clays such as bentonite, veegum and laponite.

Preferred porous materials include solid materials comprising microporer and/or mesopores, where micropores are defined as pores having a diameter of less than 2 nm and mesopores are defined as pores having a diameter between 2 and approximately 50 nm.

As examples of preferred materials can be mentioned silicas, e.g. celite, zeolites, aluminas and ceramics; preferred silicas are those with ordered, accessible micropores or mesopores of less than 50 nm and particularly preferred silicas are zeolites or other microporous and mesoporous materials with a non-zeolitic chemical composition as defined in L. B. McCUSKER et al. (Pure and Applied Chemistry 73, pp. 381-394). Examples of the zeolite may be a naturally occurring zeolite or a synthetic zeolite. Exemplary porous materials include Neusilin (supplied by Fuji Chemical Industries Inc., USA).

The chosen porous material may be suitable for one reaction and not for others. The person skilled in the art will know how to choose the porous material for a specific application.

The porous material may optionally be mixed with any process aiding substance known in the art.

The reagent delivering article of the invention is particularly useful in retaining liquid reagents, which are inert in respect of the porous material and the process aiding substance(s).

The porous material of the present invention which material is capable of retaining a liquid reagent, can be chosen depending on the liquid reagent desired to be retained, the desired absorption time of said reagent, and the desired amount which is to be retained in the reagent delivering article.

The pore size of the porous material has an impact on the article in the form of absorption rate of the liquid reagent to be retained and vapour pressure of the article retaining a liquid reagent.

Thus, a low pore size provides for lower vapour pressure and, conversely, a high pore size provides for a higher vapour pressure. Varying the pore size due to the vapour pressure is thus important when working with volatile hazardous substances, for example bromine or CS₂, for health reasons, when working with malodorous substances for well being and for increased keeping qualities.

Likewise, a high pore size provides for a lower absorption rate and, conversely, a low pore size provides for a higher absorption rate. Ideally high absorption rates are preferred speeding up the loading time for the loaded reagent delivering articles, but the absorption time may be compromised in order to avoid vaporization from the article when working with hazardous volatiles and/or malodorous substances and for increased keeping qualities.

However, it should be noted that the pore size also have an impact on the release time for a particular reagent in a particular reaction medium. Therefore is the selection of a suitable porous material for a particular reagent delivering article often a compromise between considerations to loading time, vaporization and release time.

By “void volume” in the context of the porous material is meant that in terms of volume it may be seen as having an interstitial volume/available volume, which is defined as essentially all of the volume within the article that would be accessible to a fluid entering the article, i.e. the volume surrounded by the pore surfaces which does not contain the inorganic material forming the article. The terms “interstitial volume”, “available volume” and the “void volume” may be used interchangeably.

Porous material of the invention may comprise void volumes as high as possible relative to the total volume of the porous material. For example, at least 20% (V/V), more preferably at least 30% (V/V), more preferably at least 40% (V/V), particularly more preferred at least 50% (V/V), more preferred at least 60% (V/V), and even more preferably at least 70% (V/V), most preferred at least 80% (V/V) and in a particular preferred embodiment at least 85% (V/V) depending on the intended application.

The void volumes of the preferred porous materials, zeolites, can for example constitute up to 50% (V/V) for naturally occurring zeolites and up to 85% (V/V) or more for synthetic zeolites.

The porous material may be chosen so that the reagent delivering article contains a void volume corresponding to a desired predetermined amount of a liquid reagent to be retained therein.

The size of the article may vary depending on the intended application of said article, i.e. the larger the desired amount of reagent, the larger the article. Choosing the size of the article corresponding to the desired amount of liquid reagent to be retained therein is within the skill of the art.

Thus the porous material can be selected taking due consideration to void volume, pore size, intended loading and reagent etc.

In even a further embodiment is a porous material selected having catalytic properties.

The process aiding substance is to be chosen so that it does not interfere with any of the other constituting parts of the reagent delivering article except aiding the compression and/or shaping of the article. Furthermore, the process aiding substance should not dissolve in solution.

This can be accomplished by either conducting the optional purification step (v) of the methods of the invention, resulting in an article that does not contain any substantial process aiding substance, or by using a process aiding substance, which is insoluble in the solvent to be used in the intended reaction. By “any substantial” in this context is meant that only an insignificant amount of material is dissolved, which amount is to small to have any impact on the intended chemical reaction or the purity of the intended product. The skilled person will know which substances are well suited for the above requirements.

The object of the optional purification step (v) is to remove substantially all organic material from the prepared reagent delivering article such as soluble porous material, excess/dispensable process aiding substance(s) and excess solid active substance. This ensures that the article upon use in a particular reagent medium does not release any other compounds than the reagent included in the article.

The purification may be performed using well known washing procedures e.g. by soaking into a washing fluid, such as a solvent, followed by a conventional drying operation.

The washing step also provides for the possibility of washing out the process aiding substance(s) after having aided the compressing of the inventive reagent delivering article, resulting in an article consisting essentially of porous material and, thus, no contaminating additives except optional solid active substance.

This is particularly useful when contaminating substances in a reaction mixture interfere or are suspected to interfere with the desired reaction. However, generally it is preferred to include a washing step in the preparation of the empty articles according to the invention in order to avoid any unnecessary substance in the reaction medium.

The process aiding substance and/or other organic compounds present inside the reagent delivering articles may alternatively be removed by heating the tablets to a high temperature for example above 400° C. At such a high temperature many organic compounds will evaporate or decompose and leave the tablets as a gas. The heating can be performed in the presence of oxygen, such as in ambient air in order to burn out any organic material pre-sent inside the tablets. This is possible because the tablets consisting mainly of porous material generally will be stable up the very high temperatures, such as up to 500° C. or even higher. It is within the skills of the skilled person to select a suitable temperature for heating a particular reagent delivering article containing particular organic compounds in order to efficiently remove said organic compounds from the reagent delivering articles, or alternatively to conduct simple experiments to find such suitable temperatures for particular circumstances.

In one embodiment is the porous material a material that first becomes porous after a heat treatment. In this case is it preferred that step (v) is included as a heating the formed articles in order to simultaneously remove any process aiding substance and provide the porous property of the porous material.

In a preferred embodiment the process aiding substance is a substance known within the pharmaceutical area as a lubricant. As examples of lubricants to be used in the articles according to the invention can be mentioned: stearic acid, magnesium stearate, calcium stearate, or other metallic stearate, talc, waxes and glycerides, light mineral oil, PEG, glyceryl behenate, colloidal silica, hydrogenated vegetable oil, corn starch, sodium stearyl fumerate, polyethylene glycols, alkyl sulfates, sodium benzoate and sodium acetate.

A preferred lubricant is magnesium stearate.

In another preferred embodiment the reagent delivering article according to the invention additionally comprises a glidant also known within the pharmaceutical area.

Porous materials, lubricants and glidants are well known within the area, in particular within the pharmaceutical area, where such compounds are used in a pharmaceutically acceptable quality. However, the skilled person will appreciate that for the present invention it is not necessary that the ingredients are pharmaceutically acceptable, since the requirements for the present invention only dictates that the ingredients should be inert with respect of the intended reagent and the intended reaction, and therefore does the present invention not require use of ingredients of pharmaceutically acceptable quality, i.e. the purity etc. is in accordance with officially recognized requirements such as listed in e.g the European Pharmacopoeia.

In one embodiment the ingredients of the empty article are of a pharmaceutically acceptable quality.

In another preferred embodiment, at least one of the inert porous material and the process aiding substance is not of pharmaceutically acceptable quality.

In another preferred embodiment the reagent delivering article comprises a solid active substance. The solid active substance may be solid chemical reagent, such as a metal, a catalyst, or a chemical moiety bound to a solid carrier.

In principle any chemical moiety bound to any solid carrier may be used according to the invention. Any such chemical moiety bound to any solid carrier as known in the literature or available from commercial suppliers may be use. The chemical moiety can be selected among functionalized groups of any kind that is capable of participating in a chemical reaction while bound to the solid carrier. Many such chemical moieties that may be used according to the invention is well known within the area. The solid carrier may in principle be any carrier capable of being bound to the chemical moiety and essentially inert viz the intended reaction. The solid carrier may be organic e.g. a resin based on polyurethane or polystyrene, or it may be inorganic. The skilled person will also appreciate which solid carriers may be used according the present invention.

In one preferred embodiment is the solid carrier itself a porous material capable of retaining at least one chemical reagent.

The attachment of a chemical moiety to a solid carrier is well known within the area.

The chemical moiety bound to a solid carrier may for example serve as a carrier for a particular reaction taking place on the particular moiety, where a product may be released after one of more synthesis steps, a catalyst or a scavenger.

In order to prepare reagent delivering articles comprising solid active substance according to the invention said solid active substance is mixed with the porous material and the optional process aiding substance before processing this mixture into the reagent delivering articles. The solid active substance is preferably inert in respect of the optional process aiding substance and is not converted when contacted with the porous material.

Loading of Empty Articles

Before use in chemical reactions the prepared empty articles must be loaded with the reagent to be delivered.

The reagent delivering article may be loaded with liquid reagent by bringing the empty articles in contact with the liquid reagent.

If the reagent is liquid at ambient temperature it can be loaded by soaking the reagent delivering article in the liquid reagent, loading the liquid reagent manually or automatically using a pipette or by any other means suitable for supplying a liquid to a solid article. The liquid may also be supplied to the article under pressure either to speed up the absorption time or if the liquid is very viscous and is not readily absorbed in the article.

If the reagent is solid at ambient temperature the reagent may be dissolved in a suitable solvent and the resulting solution can be loaded into the article as above. Usually it is preferred to remove the solvent by evaporation after the loading.

Alternatively, if the reagent is solid at ambient temperature it may be melted and loaded into the articles as above. After the loading the articles may be cooled to ambient temperature where the reagent will solidify inside the articles. Usually the solidified reagent will dissolve in the reaction medium at a satisfactory rate from the loaded articles. This method may be applied for reagents having a sufficient stability at the melting temperature and requires further that the porous material is stable at said melting temperature, which usually is not a problem.

If the reagent is a gas at ambient temperature the reagent may be liquefied at low temperature and loaded at low temperature. After loading it may be necessary to store the loaded articles at low temperature in order to avoid unsatisfactory high evaporation of the loaded reagent.

Even though most reagents easily are loaded into the reagent delivering articles according to the invention a few reagents resists loading be capillary force alone. For example has it shown difficult to load mercury or diethyl aminosulpha-trifluoride in a reagent delivering article according to the invention consisting essentially of Neusilin. If such difficulties are encountered the reagents may be loaded by application of higher pressure to the container in where the loading takes place, or a different reagent delivering article based on a different porous material may be used for the particular reagent.

It has been observed that for a given size and composition of a particular article according to the invention, a particular amount is loaded in the article with high reproducibility. Thus if several articles according to the invention is loaded with same reagent all the loaded articles will contain approximately same amount of the liquid reagent. It has routinely be estimated that the variance in content of loaded reagent from one loaded reagent delivering article to another loaded reagent delivering article in a series of loading same reagent delivering articles with same reagent usually is less than 5%.

Usually, is the loading degree high, i.e. the fraction of the void volume occupied by the loaded reagent is high. Preferably is the loading degree higher that 50%, more preferred higher than 60%, even more preferred higher than 70%, even more preferred higher than 80% and in particular preferred embodiments higher than 85%.

Reagents to be included in the empty articles according to the invention include organic reagents, inorganic reagents and metalorganic compounds. The reagents may be neutral compounds or salts.

The reagent delivering article may even be loaded with more than one reagent(s) e.g. by loading a mixture of the reagents into the articles. Alternative, a liquid reagent may be loaded in a porous article containing a solid active compound or functionalized groups bound to a carrier. In this way the loaded particles may e.g. provide more than one reagent to a reaction, may provide one or more reagents and functionalized groups or may provide one or more reagents as well as a catalyst.

As the organic reagent can be used liquid organic substances as such or solid organic substances dissolved in a suitable solvent. It will be within the skills of the average practitioner to select a suitable solvent for a particular reagent. As examples of suitable solvents can be mentioned water, ethanol, dimethylformamide, ethanol, tetrahydrofuran etc.

Examples of organic liquid substances include both aliphatic and aromatic sub-stances and include but are not limited to substituted aromatic rings such as m-nitrotoluene, m-bromoaniline, m-fluorophenol, 3,4-dichlorobenzylchloride, o-iodoanisole, phenylisocyanate; aromatic hetero rings such as pyridines, e.g. m-bromopyridine; aliphatic non-cyclic compounds such as hexamethylphosphoroustriamide (HMPA), diethylazodicarboxylate (DEAD), butanic acid, di-iodomethane, iodomethane and aliphatic cyclic compounds such as 15-crown-5.

Examples of organic solids include but are not limited to benzotriazol-1-yl-oxytripyrrolidinophosphonium hexafluorophosphate (PyBOP), copper (II) pivaloate, BiPh₃ and PhSeSePh.

As the inorganic liquid can be used liquid inorganic substances as such or solid inorganic substances dissolved in a solvent. Examples of inorganic liquids include but are not limited to H₂O₂ as a stable aqueous solution, Br₂, CS₂ and polymeric siloxanes such as polymeric dimethoxysiloxane.

Examples of inorganic solids that may be dissolved in a solvent e.g. water before loading include but are not limited to K₂Cr₂O₇, B₁₀H₁₄, CuSO₄.5H₂O, HgCl₂, ZnCl₂, Li—ClO₄, Cs₂CO₃, CeCl₃.7H₂O, SnCl₂.2H₂O, NH₄⁺PF₆⁻, K₂CO₃, Cu(NO₃)₂.3H₂O, KCN, FeCl₃, S₈, BiCl₃ and NH₄⁺SO₃NH₂⁻.

Further examples of organic and inorganic chemicals that may be loaded in the articles according to the invention appear in table 1 and table 2.

The selection of solvent to be used for loading a solid reagent as a solution depends on the particular reagent. Thus the solvent should be selected under due consideration to the solubility of the reagent in the solvent. It is within the skills of the average practitioner to select a suitable solvent for a particular reagent and an intended reaction. If desired different solvents for a particular reagent may be evaluated using simple comparable tests.

Usually the solvent is evaporated after loading a solution of a reagent into a reagent delivering article according to the invention.

It may even in particular circumstances be possible to load a reagent delivering article according to the invention with a solution of a reagent, followed by evaporation of the solvent and an additional loading with the same or a different liquid reagent. The evaporation of solvent and reloading may even be performed repeatedly.

Having the liquid reagent retained in the article provides for several advantages in respect of handling and manual distribution of chemicals. Articles retaining reagents evade handling large flasks containing liquid reagents and the concomitant exposure to in particular hazardous chemicals providing for a safer working environment for those working in the chemical industry.

Even though the reagent delivering articles according to the invention generally are considered inert unexpected adverse reactions have been observed with some combinations of the reagent delivering article and a liquid reagent.

For example it has been observed that phenylisocyanate loaded in an article containing Neusilin upon storage at room temperature was degraded by trimerisation to 1,3,5-triphenyl-[1,3,5]-triazine-2,4,6-trione.

In another example it has been observed that when potassium iodide loaded was loaded in an article containing Neusilin the article disintegrated slowly and fell apart.

In another example it was observed that when thallium triacetate was loaded in an article containing Neusilin the reagent decomposed and the colour of the loaded article changed from white to black.

However as it appears from table 1 and 2 the loading occurs without any problems with most chemicals without any observed problems.

Without wishing to be bound by any theory it is believed that the porous material may facilitate/promote/catalyse the degradation/polymerisation of a particular reagent.

The skilled person may based on simple experiments determine if adverse reactions take place for a particular combination of porous material and liquid reagent.

In case adverse reactions are observed, a reagent delivering article based on a different porous material may be selected for the particular reagent.

In one preferred embodiment of the invention the liquid reagent is loaded immediately before use of the article. Thus, for example a sufficient number of articles for a days work may be loaded in the morning and used same day. There may even exist situations where a more frequent loading is desired. This embodiment is preferred when the reagent in question is unstable or when the use thereof is infrequent.

Alternatively a larger portion of reagent delivering articles may be loaded periodically, e.g. weekly, monthly or less frequent, depending of the keeping properties of the liquid reagent in question. For certain combinations of reagent delivering article and reagent the loaded articles have been stored for several months or even years without any significant loss of reactivity. This embodiment is preferred when the reagent in question is frequently used and shows a satisfactory stability.

If desired simple experiments can be performed for determining the stability of a given combination of a reagent and a reagent delivering article. In case that an insufficient stability is observed a reagent delivering article comprising a different porous material should be used for the particular reagent instead of the first tested reagent delivering article.

As mentioned loading the article with reagent can be accomplished both manually and automatically. When the reagent delivering articles are loaded automatically, human contact with hazardous substances to be used when working in the laboratory, particularly when working with organic synthesis, is substantially minimized or avoided completely. Automatic loading furthermore provides for a commercial production of both standard and custom-made “pills” that are ready for use in the chemical industry and/or research laboratories.

In another embodiment the article is coated with a coating substance in order to further seal said article against environmental exposure in case the article is loaded with a volatile or labile liquid reagent and/or to protect the environment, e.g. laboratory workers, from fumes descending from the article. This is particularly useful if said article is loaded with very volatile substances that are hazardous to the environment and which are not retained sufficiently by choosing low pore sizes of the porous material.

Coating the article may further protect the loaded reagent against deterioration due to exposure to ambient air, and will further reduce expose to the reagent of the staff handling the articles.

The coating substance may include any suitable substance that does not react with the reagent retained in the article, is readily dissolved when placing the article in solution and does not react or interfere with the reaction taking place in the solution.

Coating substances for the inventive article can be any suitable conventional coating substance known in the art. The skilled person is capable of selecting suitable coating substances with due considerations to the reagent in the reagent delivering article according to the invention and the intended reaction.

The reagent delivering articles according to the invention shows a satisfactory crushing stability, which provide for a sufficient stability on transport and handling of the reagent delivering articles.

Thus the crushing strength is usually higher than 10 N, preferably higher than 20 N and most preferred higher than 30N.

Surprisingly is the stability of the reagent delivering articles according to the invention not considerable reduced when a reagent is loaded, in fact does the crushing strength often increase upon loading. For example has it been observed that a reagent delivering article essentially consisting of Neusilin, having a crushing strength of 33 N in the unloaded form, when loaded with S₈ had a crushing strength of 100 N.

Therefore is the crushing strength of the reagent delivering articles according to the invention satisfactory for handling and transport in both empty and loaded form.

Preparation of Filled Articles According to the Invention

As an alternative the reagent to be delivered may be included in the porous material before processing the ingredients into a reagent delivering article.

This embodiment may be used if it is desired to include a solid active compound into the reagent delivering article, for example a metal or a catalyst. It may also be used to include a solid reagent, which is not readily soluble in a suitable solvent, or a solid reagent, which is not stable at the melting temperature.

For preparing such filled articles the solid active compound is added to the mixture of the porous material, the optional process aiding substances and the optional solid active substances, where after the mixture is processed into reagent delivering articles according to the invention using conventional technology. After the processing, it may even be possible to load a liquid reagent into the article as described above, resulting in loaded articles according to the invention comprising a solid active compound and a liquid reagent.

In another embodiments it may even be possible to load a liquid reagent into the porous material before processing into reagent delivering articles according to the invention. The skilled person will appreciate that in such embodiments will the washing step usually not be possible.

After preparing the filled articles according to the invention they may be coated as discussed above.

Use of the Articles for Delivering Reagents

The loaded articles containing at least one reagent may in principle be used in any chemical reaction taking place in a fluid medium, where the reagent may be released from the loaded article. In particular, the invention relates to reagent delivering articles for use in solution phase chemistry.

The reagent delivering articles of the invention loaded with reagent provide a very easy means for delivering reagents to chemical reactions. In particular, complex reactions requiring multiple additions of reagent are facilitated by use of the inventive article.

Further it reduced the exposure of the staff to the reagents in the reagent delivering articles because the reagent is only present inside the article and is first released in the reaction medium. Even though the reagent delivering articles according to the invention provides for a reduced expose of the loaded reagent it is not recommended to touch the loaded articles with bare hands, because the reagent might be released by capillary action and the moisture present on the human skin may effect a minor release of reagent.

When placed in solution, the object of the reagent delivering article of the invention is that the retained liquid reagent is released therefrom. This release may occur instantaneously or over time depending on the chosen porous material, in particular depending on the pore size of the chosen material.

Thus, small pore sizes confer low release rates, and, conversely, large pore sizes confer high release rates. This is of particular interest when it is desired to be able control the supply of a reagent in a reaction. In some reactions an instant supply of reagent is required, and, reversely, in some reactions a current supply of reagent is required.

Therefore may a suitable selection of the pore size of the article according to the invention have a strong influence on the chemical reaction. The pore size may be selected to allow rapid release of the reagent into the reaction medium mimicking a single addition of reagent or the pore size may be selected to allow slow release of the reagent into the reaction medium mimicking a continuous addition of reagent.

Use of the article in parallel solution synthesis is a preferred aspect of the invention. The preloaded articles of the invention can easily be implemented for multiple reactions, providing for a rapid, reproducible means for carrying out numerous reactions simultaneously. More specifically it speeds up the synthesis of compound libraries and series and furthermore, in particular when loaded automatically, provides for a reproducibly fixed application of liquid reagents to reaction mixtures because of the improved precision and accuracy in dosing, i.e. no statistically deviations due to human error when weighing, dispersing, pipetting or measuring out reagents.

In case that a reagent delivering article according to the invention comprises functionalized groups attached to a carrier, the intended reaction may even take place inside the reagent delivering article. In this case the reagent delivering article comprising functionalized groups, optionally loaded with a chemical reagent is added to a reaction medium, where the chemical reagent is released from the reagent delivering articles, and the reaction takes place inside the articles. When the reaction is completed the reagent delivering articles may be removed from the reaction medium and transferred to a second reaction medium where another reaction takes place, which may be a release of a compound formed in a previous step, or a further reaction inside the article. It will be appreciated that several such steps may be possible.

It may even be possible to reuse reagent delivering articles according to the invention. After a first use the reagent delivering article may be purified from remnants of the first reaction medium e.g. by washing one or more times or by burning out the organic content as previously described. After the purification the reagent delivering articles may be reloaded and used for delivering reagent to a new chemical reaction.

The skilled person will appreciate that in case a reagent delivering article according to the invention contains functionalized groups these groups may be destroyed by burning our the organic material in the used tablets. For such articles washing may be the only possibility for purification before reuse.

The present invention is now illustrated by specific examples, which are presented for illustrative purposes only and should not be considered limiting of the invention.

### EXPERIMENTAL SECTION

All reactions were carried out under positive pressure of nitrogen. Unless otherwise noted, starting materials were obtained from commercial suppliers and used without further purification. Tetrahydrofuran (THF) was distilled under N₂ from sodium/benzophenone immediately prior to use. DMF was dried over molecular sieve (4 Å) prior to use. Thin layer chromatography (TLC) was performed on Merck 60 F₂₅₄ 0.25 μm silica gel plates. Microwave assisted reactions were performed with the Emrys Optimizer from Personal Chemistry. ¹H NMR and ¹H-decoupled ¹³C NMR spectra were recorded at 500.13 MHz and 125.67 MHz, respectively, on a Bruker Avance DRX 500 instrument. Unless otherwise noted, compounds were measured in deuterated chloroform (99.8%). Chemical shifts for ¹H NMR are reported in ppm with TMS as internal reference. Chemical shifts for ¹³C NMR are reported in ppm relative to chemical shifts of deuterated solvents.

Coupling constants (J values) are in Hertz. The following abbreviations are used for multiplicity of NMR signals: s=singlet, d=doublet, t=triplet, q=quartet, qui=quintet, dd=double doublet and m=multiplet. LC-MS data were obtained on a PE Sciex API150EX equipped with a Heated Nebulizer source operating at 425° C. The LC pumps were Shimadzu 8A series running with a Waters C-18 4.6×50 mm, 3.5 μm column. Solvent A 100% water+0.05% trifluoroacetic acid, solvent B 95% acetonitrile, 5% water+0.035% trifluoroacetic acid. Gradient (2 ml/min): 10% B-100% B in 4 min, 10% B for 1 min. Total time including equilibration 5 min. Injection volume 10 μL from a Gilson 215 Liquid Handler. Purities of compounds were determined by UV-detection at 254 nm and by ELSD (Evaporation Light Scattering Detection). GC-MS data were obtained on a Varian CP-3800/Saturn 2000 instrument. The column was Varian CP-Sil8 CB-MS Rapid-MS (10×0.53 mm) with He-flow 1.1 mL/min. Temperature gradient was 60° C. to 300° C. in 15 min. The mass detector was operated in EI mode. High resolution mass spectroscopy (HR MS) was obtained on a Jeol JMS-HX/HX110A mass instrument (University of Copenhagen, Denmark). The compression of tablets was performed on a single punch machine Korsch EK0 or Diaf TM20 with a tabletting speed of approximately 60 tablets/min. The crushing strength was measured with a Schleuniger 6D tablet hardness tester. Elemental analyses were performed at the University of Vienna, Department of Physical Chemistry (Vienna, Austria), with a Perkin-Elmer 2.400 CHN elemental analyzer and on CE Elantech-Termoquest Flash EA 1112 instrument (University of Copenhagen, Denmark).

Production of Tablets

Magnesium aluminium metasilicate (Neusilin US2 powder, mean particle size: 60-120 μm) and 0.5% magnesium stearate were mixed in a Turbula blender for 3 min. The mixture was compressed on a single-punch tabletting machine to compound cup shaped tablets (approximately 60 tablets/min) with a diameter of 9 mm. After compression to tablets, approximately 400 tablets (total weight 60.68 g) were liberated from the magnesium stearate by soxhlet extraction (1×24 h with 2 L methanol, 1×24 h with 2 L toluene and 1×24 h with THF). Solvents were removed in vacuo at room temperature for 16 h furnishing tablets with a total weight of 60.10 g. The average weight for one tablet was 144 mg±2% with a crushing strength of 33 N±9%. Heating the tablets in oil pump vacuum at 150° C. for 16 h furnishes water-free tablets with a total weight of 55.11 g. The average weight for one tablet was 129 mg±2% with a crushing strength of 33 N±9%. The obtained tablets (θ=9 mm) are suitable for automated parallel synthesis in equipments like the Bohdan microblock with 48 reactors (4.5 mL, θ=10 mm) equipped with polyethylene frits (pore size of approximately 25 μm).

Loading of Tablets

### Example 1.1

### Representative Procedure for the Loading of Tablets with a Liquid Organic Reagent

### [A] Loading of tablets with diethylazadicarboxylate (DEAD)

Ten unloaded Neusilin US2 tablets (1.282 g) were covered with neat diethyl azadicarboxylate (approximately 5 mL) under argon. In order to achieve maximal absorption of DEAD into the tablets, the mixture was allowed to stand without agitation for 16 hours at 5° C. Excess DEAD was removed by filtration through a glass frit (pore size approximately 1 mm). The tablets were rapidly rinsed 2× with à 50 ml of DCM and subsequently dried in vacuo for 16 h at room temperature furnishing tablets with a loading of 1.4 mmol DEAD/tablet. In order to test the chemical stability of the embedded reagent (after four months at 5° C.) one tablet was extracted with CDCl₃ and the filtrate was analyzed by ¹³C NMR demonstrating that DEAD practically remains unchanged over this time.

### Example 1.2

Representative Procedure for the Loading of Tablets with a Solid Organic Reagent.

### [A] Loading of tablets with benzotriazol-1-yloxytris(pyrrolidino)phosphonium hexafluorophosphate (PyBOB)

To 3.0 mL of a 1.3 M solution of PyBOB in DCM were added 10 unloaded Neusilin US2 tablets (1.292 g) at room temperature. After 3 h the tablets were separated from the solution by filtration of the mixture through a glass frit (pore size approximately 1 mm). The tablets were rapidly rinsed 2× with à 15 ml of DCM and subsequently dried in vacuo for 16 h at room temperature furnishing tablets with a loading of 0.30 mmol PyBOP/tablet.

### [B] Loading of tablets with 9,10-diphenyl-anthracene

In a sealed flask three unloaded Neusilin US2 tablets (in total 429.9 mg) and 1.5 g (4.54 mmol) 9,10-diphenyl-anthracene (mp 245-248° C.) were heated to 270° C. After 2 h the excess of molten 9,10-diphenyl-anthracene was removed with a glass pipette and the tablet surface was immediately afterwards cleaned on filter paper yielding tablets with a loading of 0.69 mmol 9,10-diphenyl-anthracene/tablet.

### Example 1.3

Representative Procedure for the Loading of Tablets with a Liquid Non-Organic Reagent.

### [A] Loading of tablets with Bromine

To 25 mL of bromine were added 30 unloaded Neusilin US2 tablets (4.28 g) at room temperature. After 2 h the tablets were separated from bromine by filtration of the mixture through a glass frit (pore size approximately 1 mm). After filtration the tablet surface was liberated from excess bromine by evaporation for approximately 30 seconds at room temperature and atmospheric pressure furnishing tablets with a loading of 4.7 mmol bromine/tablet. The fuming tablets were stored in a sealed flask at 5° C.

### Example 1.4

Representative Procedure for the Loading of Tablets with a Solid Non-Organic Reagent.

### [A] Loading of tablets with mercury(II) chloride

To 2.0 mL of a 3.3 M solution of mercury(II) chloride in acetone were added 5 unloaded Neusilin US2 tablets (0.707 g) at room temperature. After 2 h the tablets were separated from the solution by filtration of the mixture through a glass frit (pore size approximately 1 mm). The tablets were rapidly rinsed 2× with à 10 ml of acetone and subsequently dried in vacuo for 16 h at room temperature furnishing tablets with a loading of 1.0 mmol HgCl₂/tablet.

### [B] Loading of tablets with bis(triphenylphosphine)palladium(II) chloride

A blended mixture of bis(triphenylphosphin)palladium(II) chloride (80 mg, 114 μmol) and 400 mg Neusilin US2 powder was compressed on an IR-tabletting machine (1130 kg/cm², approximately 2 min) to furnish four tablets with a diameter of 13 mm and with a loading of 29 μmol bis(triphenylphosphin)palladium(II) chloride/tablet.

### [C] Loading of tablets with bismuth(III) chloride

In a sealed flask three unloaded and dried Neusilin US2 tablets (in total 381.3 mg) and 5.0 g (15.9 mmol) bismuth(III) chloride (mp 230° C.) were heated to 260° C. After 2 h the excess of molten bismuth(III) chloride was removed with a glass pipette and the tablet surface was immediately afterwards cleaned on filter paper yielding tablets with a loading of 2.94 mmol bismuth(III) chloride/tablet.

Following is a complete list of substrates loaded in similar manner to the representative substrates of the preceding examples 1.1-1.4. It is within the skill of the art to adapt the above-described exemplary procedures to the specific substrates mentioned below in the tables 1 and 2.

TABLE 1
Loading of liquid organic and inorganic chemicals

| Entry | | Loading^{[b]} | Occupancy^{[c]} | Strength^{[d]} |
|---|---|---|---|---|
| # | Substrate^{[a]} | (mmol/tablet) | (vol %) | [N] |
| 1 | nBu₃SnH | 0.9 | 91 | 35 |
| 2 | 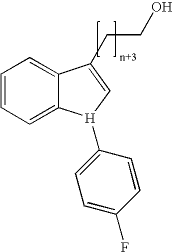 | 1.0^{e)} | 90 | Nd |
| 3 | 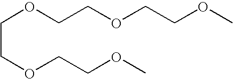 | 1.1 | 90 | Nd |
| 4 | 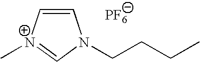 | 1.1 | 87 | Nd |
| 5 | 15-crown-5 | 1.2 | 89 | Nd |
| 6 | CF₃(CF₂)₄CF₃ | 1.2 | 88 | Nd |
| 7 | 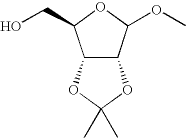 | 1.3 | 89 | Nd |
| 8 | HMPA | 1.3 | 90 | 37 |
| 9 | DEAD | 1.4 | 83 | 40 |
| 10 | 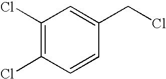 | 1.5 | 78 | 45 |
| 11 | 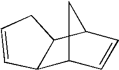 | 1.7 | 85 | Nd |
| 12 | 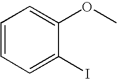 | 1.7 | 84 | 32 |
| 13 | (EtO)₂POH | 1.8 | 87 | Nd |
| 14 | 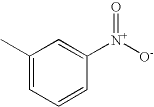 | 2.0 | 87 | Nd |
| 15 | 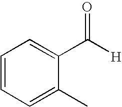 | 2.0 | 88 | Nd |
| 16 | 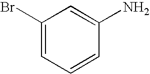 | 2.2 | 86 | Nd |
| 17 | PhNCO | 1.9 | 89 | Nd |
| 18 | 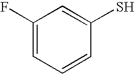 | 2.1 | 77 | Nd |
| 19 | 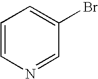 | 2.3 | 82 | Nd |
| 20 | 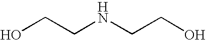 | 2.5^{[e]} | 85 | Nd |
| 21 | CH₂(CH₂)₂CO₂H | 2.5 | 90 | Nd |
| 22 | 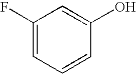 | 2.6 | 88 | Nd |
| 23 | CH₃I | 2.9 | 87 | Nd |
| 24 | CH₂I₂ | 3.8 | 87 | Nd |
| 25 | CS₂ | 3.5 | 79 | Nd |
| 26 | Br₂ | 4.7 | 91 | Nd |
| 27 | Polydimethylsiloxane | 100 mg/tablet^{[e]} | — | Nd |

^{[a]}Substrates are ranked according to increasing molar density [mmol/cm³];
^{[b]}If not mentioned, loading time of substrates are in the range of 1-2 h;
^{[c]}Percentage of the maximal theoretical loading;
^{[d]}Loading was performed at 80° C. for 16 h;
nd = not determined.

TABLE 2
Loading of solid organic and inorganic chemicals

| Entry | | c/(mol/L) | | Loading | Strength |
|---|---|---|---|---|---|
| # | Substrate | (solvent, T/° C.) | | (mmol/tablet) | [N] |
| 1 | 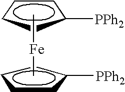 | 0.3 | (DCM, rt) | 0.04 | Nd |
| 2 | PyBOP | 1.3 | (DCM, rt) | 0.3 | Nd |
| 3 | K₂Cr₂O₇ | 0.4 | (H₂O, rt) | 0.1 | 39 |
| 4 | Cu(piv)₂ | 0.8 | (acetone, rt) | 0.2 | 30 |
| 5 | B₁₀H₁₄ | 2.0 | (DCM, rt) | 0.6 | Nd |
| 6 | CuSO_{4*}5H₂O | 2.5 | (H₂O, rt) | 0.4 | Nd |
| 7 | HgCl₂ | 3.3 | (acetone, rt) | 1.0 | 47 |
| 8 | ZnCl₂ | 3.7 | (EtOH, rt) | 0.8 | 37 |
| 9 | LiClO₄ | 3.9 | (H₂O, rt) | 2.5 | Nd |
| 10 | Cs₂CO₃ | 5.0 | (H₂O, rt) | 1.2 | 76 |
| 11 | CeCl_{3*}7H₂O | 5.0 | (H₂O, rt) | 0.6 | Nd |
| 12 | BiPh₃ | 5.1 | (THF, rt) | 0.7 | Nd |
| 13 | SnCl₂•2H₂O | 5.5 | (EtOH, 70° C.) | 0.8 | 36 |
| 14 | NH₄⁺PF₆⁻ | 6.7 | (H₂O, rt) | 1.4 | 48 |
| 15 | K₂CO₃ | 9.0 | (H₂O, rt) | 1.3 | 24 |
| 16 | Cu(NO₃)_{2*}3H₂O | 10.0 | (H₂O, rt) | 1.4 | Nd |
| 17 | KCN | 10.0 | (H₂O, rt) | 3.3 | 31 |
| 18 | FeCl₃ | 10.0 | (H₂O, rt) | 2.4 | Nd |
| 19 | H₂O₂ | 10.3 | (H₂O, rt) | 2.7 | Nd |
| 20 | 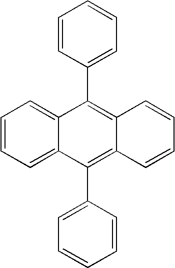 | neat | (260° C.) | 0.7 | 100 |
| 21 | PhSeSePh | neat | (80° C.) | 1.2 | 151 |
| 22 | S₈ | neat | (165° C.) | 1.7 | 100 |
| 23 | BiCl₃ | neat | (260° C.) | 2.9 | 217 |
| 24 | NH₄⁺SO₃NH₂⁻ | neat | (145° C.) | 3.4 | 402 |

Profiling of Tablets: Release- and Absorptionrates

### Example 2.1

### Representative Procedure

### Determination of the Absorption Rate of Neat 2-iodoanisole into Unloaded Neusilin Us2 Tablets

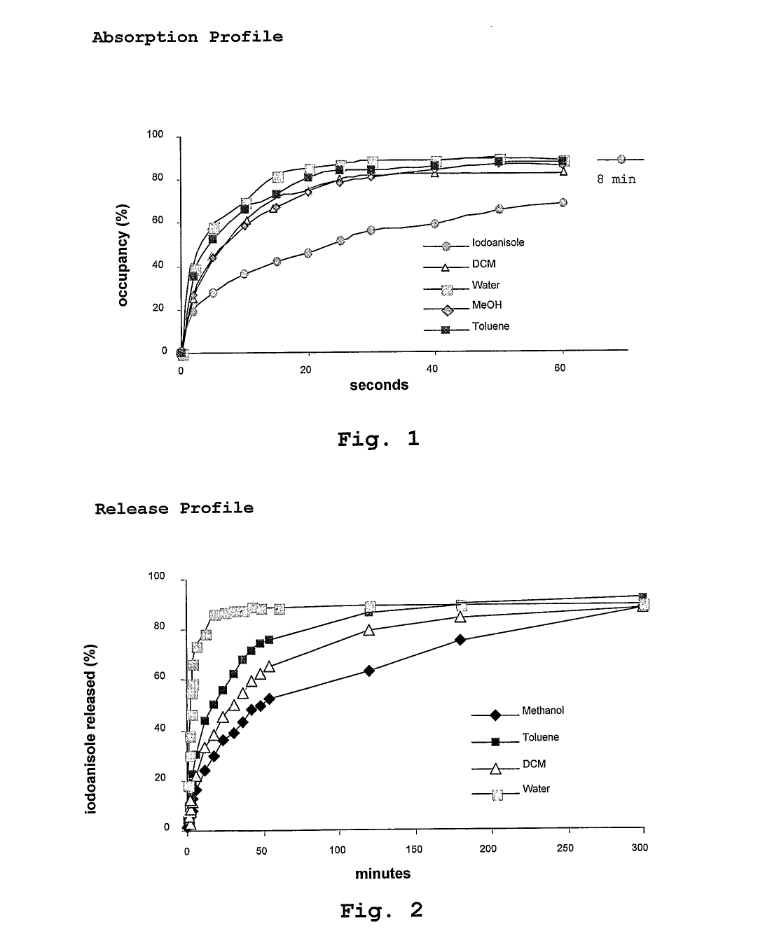

All experiments were carried out in Bohdan micro reactors (4.5 mL, φ=10 mm, equipped with a polyethylene frit; pore size approximately 25 μm). Pre-weighted and unloaded Neusilin US2 tablets were covered at room temperature with 2 mL neat 2-iodoanisole for: 2 sec; 5 sec; 10 sec; 15 sec; 20 sec; 25 sec; 30 sec; 40 sec; 50 sec; 1.0 min; 1.5 min; 2 min; 6 min; 8 min and 16 h. For each absorption experiment one individual, pre-weighted tablet was used and 2-iodoanisole was rapidly separated from the tablet by applying vacuum underneath the frit of the micro reactor. Immediately afterwards, the tablet surface was dried on filter paper and the tablet weight was determined. Each experiment was repeated three times in order to minimize experimental errors. The absorption rates of DCM, toluene, methanol and water were determined according to the procedure above (FIG. 1).

### Example 2.2

### Representative Procedure

### Determination of the Release Rate of 2-Iodoanisole From Neusilin US2 Tablets into Solvents

All experiments were carried out in Bohdan micro reactors (4.5 mL, φ10 mm, equipped with a polyethylene frit; pore size approximately 25 μm). Pre-weighted Neusilin US2 tablets containing 2-iodoanisol (398 mg±1%, 1.7 mmol±1%) were exposed in 2 mL DCM for: 30 sec; 1.0 min; 1.5 min; 2.0 min; 2.5 min; 3.0 min; 4.0 min; 6.0 min; 12 min; 18 min; 24 min; 30 min, 36 min; 42 min; 48 min; 54 min; 1 h; 2 h; 3 h; 5 h; 20 h. For diffusion experiment one individual, pre-weighted tablet was used and DCM was rapidly separated from the tablet by applying vacuum underneath the frit of the micro reactor. The solvent was removed from the tablet under vacuum for 16 h at room temperature and the tablet weight was determined. Each experiment was repeated three times in order to minimize experimental errors. The diffusion rates in toluene, methanol and water were determined according to the procedure above (FIG. 2).

Performance of Organic Reactions with and without Use of Tablets

### Example 3.1

### 5-Nitro-2-(2-phenylsulfanyl-ethyl)-isoindole-1,3-dione 1

### [A] By use of tablets containing diethylazodicarboxylate (DEAD)

To a solution of 5-nitro-isoindole-1,3-dione (250 mg, 1.3 mmol, 1.0 eq.), 2-sulfanyl-ethanol (252 mg, 1.6 mmol, 1.2 eq.) and triphenylphopshine (921 mg, 3.5 mmol, 2.7 eq.) in 20 mL THF was added three freshly prepared tablets containing (in total) 680 mg (3.9 mmol, 3.0 eq.) diethylazodicarboxylate (227 mg/tablet, 1.3 mmol/tablet) at 0° C. The reaction mixture was gently stirred for one hour at 0° C. and subsequently 15 hours at room temperature. The tablets were removed by filtration and extracted 2× with à 5 mL THF. The filtrate was diluted with 200 mL ethylacetate, washed 2× with à 25 mL water and with 25 mL brine. After drying of the organic phase over MgSO₄ and removal of the solvents by evaporation in vacuo the residue was purified by column chromatography (heptane/ethyl acetate 12:1) yielding 362 mg (1.10 mmol, 85% yield) of the desired product 1 as a yellow solid (GC-MS: 96% purity, Rₜ=10.7 min). MS (m/e) 328 M⁺. Mp 120-121° C. ¹H NMR δ 3.27 (t, 2H, J=6.8), 3.99 (t, 2H, J=6.8), 7.09 (t, 1H, J=7.3), 7.21 (t, 2H, J=7.8), 7.38 (d, 1H, J=7.1), 7.98 (d, 2H, J=7.1), 8.58 (dd, 1H, J₁=8.3 and J₂=2.1), 8.60 (d, 1H, J=1.9). ¹³C NMR δ 32.1, 38.8, 119.1, 124.8, 127.0, 129.4, 129.6, 130.5, 133.7, 134.9, 136.7, 152.1, 166.0, 166.3.

### [B] By Use of tablets containing 5-nitro-isoindole-1,3-dione

In analogy to the procedure above the synthesis of 1 was carried out with one tablet containing 5-nitro-isoindole-1,3-dione (207 mg, 1.1 mmol, 1.0 eq.). After column chromatography (heptane/ethyl acetate 12:1) 228 mg (0.69 mmol, 63% yield) 1 was obtained (GC-MS: 82% purity).

### [C] Conventional preparation without use of tablets

The conventional preparation of 1 was analogously carried out with 1.2 mmol of 5-nitro-isoindole-1,3-dione. After column chromatography (heptane/ethyl acetate 12:1) 329 mg (1.0 mmol, 84% yield) 1 was obtained (GC-MS: 99% purity).

### Example 3.2

### 4-(3,4-Dichloro-benzyl)-piperazine-1-carboxylic acid tert-butyl ester 2

### [A] By use of tablets containing 3,4-dichlorobenzylchloride

To a solution of piperazine-1-carboxylic acid tert-butyl ester (242 mg 1.3 mmol, 1.0 eq.) and diisopropyl-ethylamine (DIEA) (1.01 g, 7.8 mmol, 6.0 eq.) in 3 ml THF was added one tablet containing 3,4-dichlorobenzylchloride (306 mg, 1.6 mmol, 1.2 eq.) (note: 3,4-dichlorobenzylchloride tablets was loaded one year before!!). The reaction mixture was gently stirred for 16 hours at 60° C. The tablet was removed by filtration and extracted 2× with à 5 mL THF. The filtrate was removed from the solvent by evaporation in vacuo. The residue was dissolved in 100 mL ethylacetate and the organic phase was washed with 25 mL water and 25 mL brine. The mixture was dried over MgSO₄ and after filtration the solvent was removed by evaporation in vacuo. The residue was purified by column chromatography (hexane/ethylacetate=8:1) furnishing 341 mg (0.99 mmol, 76% yield) of the desired product 2 as colourless solid (GC-MS: 99% purity, Rₜ=9.5 min). MS (m/e) 345 M⁺. Mp 75-76° C. (without re-crystallization). ¹H NMR δ 1.46 (s, 9H), 2.37 (m broad, 4H), 3.43 (t, 4H, J=4.9), 3.44 (s, 2H), 7.16 (dd, 1H, J₁32 8.2 J₂=1.9), 7.38 (d, 1H, J=8.2), 7.43 (d, 1H, J=1.9). ¹³C NMR δ 28.4, 43.5 (broad), 52.8, 61.8, 79.7, 128.2, 130.2, 130.7, 131.0, 132.4, 138.5, 154.8. Anal. Calcd for C₁₆H₂₂Cl₂N₂O₂: C, 55.66; H, 6.42; N, 8.11. Found: C, 55.65; H, 6.43; N, 8.08.

### [B] Conventional preparation without use of tablets

The conventional preparation of 2 was analogously carried out using 300 mg (1.5 mmol, 1.2 eq.) 3,4-dichlorobenzylchloride. After column chromatography (hexane/ethylacetate=8:1) 332 mg (0.93 mmol, 77% yield) 2 was obtained (GC-MS: 99% purity).

### Example 3.3

### 1-(4-tert-Butylphenyl)sulfanyl-4-nitro-benzene 3

### [A] By use of tablets containing potassium carbonate

A mixture of 4-tert-butyl benzenethiol (3.00 g, 18.0 mmol, 1.2 eq), 4-fluoronitrobenzene (2.11 g, 15.0 mmol, 1.0 eq) and 28 tablets containing (in total) 5.12 g (37 mmol, 2.5 eq.) potassium carbonate (183 mg/tablet, 1.32 mmol/tablet) in 75 mL THF was heated to reflux under gentle stirring for 16 h. The tablets and excess of potassium carbonate were removed by filtration and extracted 3× with à 50 mL THF. The solvent was removed by evaporation in vacuo and the residue was suspended in 100 mL ethylacetate and washed 2× with à 50 mL water and 50 mL brine. The mixture was dried over MgSO₄ and after filtration the solvent was removed by evaporation in vacuo. The residue (5.33 g) was purified by column chromatography (hexane/ethylacetate=15:1) furnishing 4.13 g (14.4 mmol, 96% yield) of the desired product 3 as yellow solid (GC-MS: 98% purity, Rₜ=9.2 min). MS (m/e) 287 M⁺. Mp 65-66° C. (without re-crystallization). ¹H NMR δ 1.36 (s, 9H), 7.15 (d, 2H, J=8.9), 7.47 (s, 4H), 8.04 (d, 2H, J=8.9). ¹³C NMR δ 31.2, 34.8, 124.0, 126.3, 126.6, 127.1, 134.7, 145.2, 149.1, 153.3.

### [B] Conventional preparation without use of tablets

The conventional preparation of 3 was analogously carried out using 5.18 g (38 mmol) potassium carbonate. After column chromatography (hexane/ethylacetate=15:1) 4.13 g (14.4 mmol, 96% yield) 3 was obtained as yellow solid (GC-MS: 96% purity).

### Example 3.4

### 1,2-Dibromo-4,5-dimethoxy-benzene 4

### [A] By application of bromine tablets

A gently stirred solution of 1,2-dimethoxy-benzene (veratrol) (6.9 g, 50.0 mmol) in 50 mL tetrachlormethane was cooled to 0° C. and 24 tablets containing (in total) 17.9 g (112.0 mmol, 2.2 eq.) bromine (746 mg/tablet, 4.67 mmol/tablet) were added carefully (three tablets at a time) over a period of approximately 20 min ensuring that the reaction temperature was not raising above +5 C. After complete bromine addition the reaction mixture was stirred for further 2 h at 0-5° C. The tablets were removed by filtration and extracted 2× with à 50 mL tetrachlormethane. The filtrate was washed 2× with à 10 mL of 10% aqueous solution of NaHSO₃, subsequently 2× with à 10 mL of 10% aqueous solution of NaOH and finally 2× with à 25 mL of water and with 25 mL of brine. The organic phase was dried over Na₂SO₄ and filtered and liberated from the solvent by evaporation in vacuo. The residue was re-crystallized (ethanol) furnishing 13.3 g (44.9 mmol, 90% yield) of 1,2-dibromo-4,5-dimethoxy-benzene 4 as colourless crystals (GC-MS: 100% purity, Rₜ=5.9 min). MS (m/e) 296 M⁺. Mp 84-86° C. (ethanol). ¹H NMR δ 3.85 (s, 6H), 7.06 (s, 2H). ¹³C NMR δ 56.7, 115.2, 116.4, 149.3.

### [B] By conventional preparation without use of tablets

The conventional bromination procedure was analogously carried out using a solution of bromine (17.6 g, 110.1 mmol, 2.2 eq.) in 10 mL tetrachlormethane instead of tablets of bromine. After re-crystallisation 13.8 g (46.6 mmol, 93% yield) of 1,2-dibromo-4,5-dimethoxy-benzene 4 was obtained (GC-MS: 99% purity).

### Example 3.5

### 4-Phenylcarbamoyl-piperazine-1-carboxylic acid tert-butyl ester 5

### [A] By use of tablets containing phenylisocyanate

To a solution of piperazine-1-carboxylic acid tert-butyl ester (300 mg, 1.6 mmol, 1.0 eq.) in 3 mL THF was added one tablet containing phenylisocyanate (228 mg, 1.9 mmol, 1.2 eq.) at room temperature (note: the tablet was used within three days after loading; prolonged storage at room temperature cause degradation of the embedded phenylisocyanate by trimerisation to 1,3,5-triphenyl-[1,3,5]triazane-2,4,6-trione). The mixture was gently stirred at room temperature for 16 h and diluted with 50 mL ethylacetate. The tablet was removed by filtration and extracted 2× with à 5 mL ethylacetate. The filtrate was washed 3× with à 50 mL water and 25 mL brine and dried over MgSO₄. After filtration the solvent was evaporated in vacuo and the oily residue was purified by column chromatography (hexane/ethylacetate=7:1) furnishing 429 mg (1.4 mmol, 88% yield) of the desired product 5 as colourless solid (LC-MS: 90% UV-purity and 99% ELSD-purity; Rₜ=2.5 min). MS (m/e): 250 (M⁺+1−C₄H₈), 206 M⁺+1-Boc. Mp 168-169° C. (without re-crystallization). ¹H NMR δ 1.48 (s, 9H), 3.46 (s, 8H), 6.56 (s, 1H), 7.1 (t, 1H, J=7.3), 7.2-7.4 (m, 4H); ¹³C NMR δ 28.8, 43.5 (broad), 44.2 (broad), 80.7, 120.8, 123.7, 129.2, 139.4, 155.0, 155.7. Anal. Calcd for C₁₆H₂₃N₃O₃: C, 62.93; H, 7.59; N, 13.76; Found: C, 63.35; H, 7.35; N, 13.43. HR MS calcd for C₁₆H₂₃N₃O₃: m/e 305.1739; Found: m/e 305.1705.

### [B] Conventional preparation without use of tablets

The conventional preparation of 5 was analogously carried out using 298 mg (1.6 mmol, 1.0 eq.) piperazine-1-carboxylic acid tert-butyl ester. After column chromatography (hexane/ethylacetate=7:1) 421 mg (1.4 mmol, 86% yield) 5 were obtained as colourless solid (LC-MS: 94% UV-purity and 100% ELSD-purity).

### Example 3.6

### 2-(4-Methoxy-benzylidene)-malononitrile 6

### [A] By use of tablets containing zinc(II) chloride

A mixture of neat 4-methoxy-benzaldehyde (1.36 g, 10.0 mmol, 1.0 eq), neat malononitrile (0.66 g, 10.0 mmol, 1.0 eq) and 2 tablets containing (in total) 206 mg (1.5 mmol, 15 mol %) zinc(II) chloride (103 mg/tablet, 0.76 mmol/tablet) was heated to 100° C. under gentle stirring for 90 min. The reaction mixture was cooled to room temperature and dissolved in 75 mL ethylacetate/DCM (5:1). The tablets were removed by filtration and extracted 2× with à 50 mL ethylacetate/DCM (5:1). The filtrate was washed 2× with à 50 mL water and with 50 mL brine. After drying over MgSO₄ and filtration, the solvents were removed by evaporation in vacuo yielding the desired product 6 (1.78 g, 9.7 mmol, 97% yield) as yellow solid in high purity without further purification (GC-MS: 99% purity, Rₜ=6.4 min). MS (m/e) 184 M⁺. Mp 108-109° C. ¹H NMR δ 3.92 (s, 3H), 7.01 (d, 2H, J=8.9), 7.65 (s, 1H), 7.91 (d, 2H, J=8.9). ¹³C NMR δ 55.6, 113.1, 114.2, 114.9, 123.8, 133.2, 158.6, 164.6.

### [B] Conventional preparation without use of tablets

The conventional preparation of 6 was analogously carried out using neat 4-methoxy-benzaldehyde (1.36 g, 10.0 mmol, 1.0 eq), neat malononitrile (0.66 g, 10.0 mmol, 1.0 eq) and neat zinc(II) chloride (136 mg, 1.0 mmol, 15 mol %) furnishing 1.81 g (9.82 mmol, 98% yield) 6 (GC-MS: 95% purity).

### Example 3.7

### [2-tert-Butoxycarbonylamino-3-(4-tert-butoxy-phenyl)-propionyl-amino]-acetic acid tert-butyl]ester 7

### [A] By application of benzotriazol-1-yloxytris(pyrrolidino)phosphonium hexafluorophosphate (PyBOB) tablets

To a gently stirred solution of (S)-2-tert-butoxycarbonylamino-3-(4-tert-butoxyphenyl)propionic acid (337.5 mg, 1.0 mmol, 1.0 eq.) in 5 mL DCM were added amino acedic acid tert-butyl ester (144.3 mg, 1.1 mmol, 1.1 eq.), diisopropylethylamine (DIEA) (362.0 mg, 2.8 eq.) and 5 tablets containing (in total) 660 mg (1.3 mmol, 1.3 eq.) PyBOB (132 mg/tablet, 0.25 mmol/tablet) at room temperature. The mixture was stirred at room temperature for 16 h and diluted with 50 mL DCM. The tablets were removed by filtration and extracted 2× with à 10 mL DCM. The filtrate was after washed 3× with à 50 mL water and dried over MgSO₄. After filtration the solvent was evaporated in vacuo and the oily residue was purified by column chromatography (hexane/ethylacetate=4:1) furnishing 366.4 mg (0.81 mmol, 81% yield) of the desired product 7 (>95% pure by ¹H NMR) as viscous colourless oil. ¹H NMR (CD₂Cl₂) δ 1.35 (s, 9H), 1.42 (s, 9H), 1.49 (s, 9H), 2.95 (dd broad, 1H, J₁=13.7, J₂=8.0), 3.12 (dd, 1H, J₁=14.1, J₂=6.1), 3.86 (dd, 1H, J₁=18.1, J₂=5.4), 3.93 (dd, 1H, J₁=18.1, J₂=5.4), 4.42 (m broad, 1H), 5.32 (d broad, J=7.5, 1H), 6.72 (m broad, 1H), 6.93 (d, 2H, J=8.5), 7.14 (d, J=8.0, 2H). ¹³C NMR (CD₂Cl₂) δ 28.5, 28.8, 29.4, 30.5, 38.5, 42.7, 56.4, 78.9, 80.5, 82.8, 124.8, 130.5, 132.5, 155.1, 156.2, 169.5, 172.4. Anal. calcd for C₂₄H₃₈N₂O₆: C, 63.98; H, 8.50; N, 6.22; found: C, 64.12; H, 8.74; N, 6.04.

### [B] By conventional preparation without use of tablets

The conventional amide formation procedure was analogously carried out using neat 520.4 mg (1.0 mmol, 1.0 eq.) PyBOB. After column chromatography (hexane/ethylacetate=4:1) 361.0 mg (0.80 mmol, 80% yield) of 7 (>95% pure by ¹H NMR).

### Example 3.8

### Dibenzyl Sulfone 8

### [A] By application of hydrogen peroxide tablets

Dibenzyl sulfide (3.6 g, 16.8 mmol, 1.0 eq.) is first completely dissolved at 75° C. in 20 mL acetic acid. Subsequently 19 tablets containing (in total) 5.01 g of a 35% aqueous solution of hydrogen peroxide (1.75 g, 51.5 mmol, 3.1 eq. of neat hydrogen peroxide) (92 mg/tablet, 2.71 mmol/tablet) are added in small portions (three tablets at a time) to the gently stirred mixture over a period of approximately 30 min ensuring that the reaction temperature was not raising above 75° C. The reaction mixture was gently stirred for additional 3-4 h at 75° C. After cooling to room temperature the tablets were removed by filtration and extracted 2× with à 10 mL acetic acid. The filtrate was concentrated by evaporation of approximately 20 mL acetic acid in vacuo and stored at 4° C. overnight. The desired product crystallized as colourless crystals that were isolated by filtration and drying in in vacuo at 60° C. overnight furnishing 3.87 g (15.7 mmol, 94% yield) of 8 (GC-MS: 99% purity, Rₜ=8.2 min). Mp 148-150° C. ¹H NMR δ 4.13 (s, 4H), 7.40 (m, 10H). ¹³C NMR δ 58.4, 127.9, 129.4, 131.3.

### [B] By conventional preparation without use of tablets

The conventional oxidation procedure was analogously carried out using 4.85 g of a 35% aqueous solution of hydrogen peroxide (1.70 g, 49.9 mmol, 3.0 eq. of neat hydrogen peroxide). After crystallisation from acetic acid and drying 3.68 g (14.9 mmol, 89% yield) of 8 were obtained (GC-MS: 85% purity).

### Example 3.9

### 4-Methoxy-aniline 9

### [A] By application of tin(II) chloride dihydrate tablets

A gently stirred mixture of 4-methoxy-nitrobenzene (765.7 mg, 5.00 mmol, 1.0 eq.) and 30 tablets containing (in total) 5.58 g (24.7 mmol, 4.9 eq.) tin(II) chloride dihydrate (186 mg/tablet, 0.82 mmol/tablet) in 80 mL THF was heated to reflux for 16 h. The tablets were removed by filtration and extracted 3× with à 10 mL ethanol. The filtrate was removed from the solvents by evaporation in vacuo and the residue was treated with 50 mL water and basified (to pH≈10) with 2 M aqueous solution of NaOH. The mixture was extracted 2× with à 100 mL ethylacetate and the resulting organic phase was washed with 25 ml water and 25 mL brine and dried over MgSO₄. After filtration and removal of the solvent by evaporation in vacuo the residue was purified by column chromatography (hexane/ethylacetate=5:1) furnishing 579.0 mg (4.7 mmol, 94% yield) of 9 (GC-MS: 95% purity, Rₜ=3.1 min). MS (m/e) 123 M⁺. Mp 55-59° C. ¹H NMR δ 3.41 (s broad, 2H), 3.69 (s, 3H), 6.58 (d, 2H, J=8.9), 6.71 (d, 2H, J=8.9); ¹³C NMR δ 5 56.1, 115.3, 116.8, 140.6, 153.1.

### [B] By conventional Preparation without use of tablets

The conventional reduction procedure was analogously carried out using neat 5.64 g (25.0 mmol, 5.0 eq.) tin(II) chloride dihydrate. After column chromatography (hexane/ethylacetate=5:1) 580.0 mg (4.7 mmol, 94% yield) of 9 (GC-MS: 97% purity).

### Example 3.10

### (4-Nitro-phenyl)-(1-phenyl-ethyl)-amine 10

### [A] By application decaborane(14) tablets

A gently stirred solution of 4-nitro-phenylamine (199.0 mg, 1.44 mmol, 1.0 eq.) and acetophenone (173.0 mg, 1.44 mmol, 1.0 eq.) was treated with 3 tablets containing (in total) approximately 228 mg (1.87 mmol, 1.3 eq.) decaborane(14) (approximately 0.62 mmol/tablet) in 20 mL methanol at room temperature. The mixture was stirred at room temperature for 16 h. The tablets were removed by filtration and extracted 2× with à 10 mL methanol. The filtrate was removed from the solvents by evaporation in vacuo and the residue was purified by column chromatography (hexane/ethylacetate=8:1) furnishing 266.4 mg (1.1 mmol, 76% yield) of 10 (GC-MS: 97% purity, Rₜ=9.0 min). MS (m/e) 243 M⁺+1. Mp 95-96° C. (diethyether/pentane). ¹H NMR 1.58 (d, 3H, J=6.6), 4.60 (quin, 1H, J=6.5), 4.81 (s broad, 1H), 6.46 (d, 2H, J=8.9), 7.26 (m, 1H), 7.31 (d, 2H, J=6.6), 7.34 (t, 2H, J=7.3), 8.00 (d, 2H, J=8.9). ¹³C NMR δ 24.5, 53.3, 111.9, 125.6, 126.2, 127.5, 129.0, 138.2, 143.3, 152.3.

### [B] By conventional preparation without use of tablet

The conventional reduction amination procedure was analogously carried out using neat 88.0 mg (0.72 mmol, 0.5 eq.) decaborane(14). After column chromatography (hexane/ethylacetate=8:1) 350.0 mg (1.4 mmol, 100% yield) of 10 (GC-MS: 95% purity).

### Example 3.11

### 4-{2-[2-(2-Ethoxy-ethoxy)-ethoxy]-ethoxy}-biphenyl 11

### [A] By application tributylstannane tablets

A gently stirred mixture of 4-{2-[2-(2-phenylselanyl-ethoxy)ethoxy]ethoxy}-biphenyl 14 (350.0 mg, 0.79 mmol, 1.0 eq.), 2,2′-azobis(isobutyronitrile) (AIBN) (25.0 mg, 0.15 mmol, 0.2 eq.) and one tablet containing tributylstannane (267.0 mg, 0.92 mmol, 1.2 eq.) in 20 mL toluene was heated for 16 h at 90° C. The tablet was removed by filtration and extracted 2× with à 5 mL toluene. The filtrate was removed from the solvents by evaporation in vacuo and the residue was purified by column chromatography (hexane/ethylacetate=15:1). It was not possible to remove the remaining starting material completely. After the second column chromatography 159.1 mg of a mixture of product 11 and starting material 14 (approximately 17:5 by ¹H NMR) was obtained. The yield for 11 was corrected by ¹H-NMR to 123.1 mg (0.43 mmol, 54% yield). GC-MS: Rₜ=8.9 min; MS (m/e) 286 M⁺; starting material 14 not detectable. ¹H NMR δ 1.22 (t, 3H, J=7.1), 3.55 (qui, 2H, J=6.9), 3.62 (t, 2H, J=5.0), 3.74 (t, 2H, J=5.2), 3.89 (t, 2H, J=5.0), 4.18 (t, 2H, J=5.0), 6.99 (d, 2H, J=9.0), 7.29 (t, 1H, J=7.5), 7.41 (t, 2H, J=8.0), 7.51 (d, 2H, J=8.5), 7.54 (d, 2H, J=7.5). ¹³C NMR δ 15.6, 67.1, 67.9, 70.2, 70.3, 71.4, 115.3, 127.1, 127.2, 128.5, 129.1, 134.3, 141.2, 158.8.

### [B] By conventional preparation without use of tablets

The conventional homolysis procedure was analogously carried out with 278.0 mg (0.96 mmol, 1.2 eq.) tributylstannane. After the second column chromatography (hexane/ethylacetate=15:1) 221.4 mg of a mixture of product 11 and starting material 14 (approximately 58:5) was obtained. The yield for 11 was corrected by ¹H-NMR to 185.5 mg (0.65 mmol, 82% yield).

### Example 3.12

### Naphthalene 12

Preparation of a 0.1 M solution of samarium (II) iodine in THF (150 mL solution).

Neat 1,2-diiodoethane was extracted with excess of an approximately 10% aqueous solution of NaS₂O₃ in a separation funnel until it became colourless. The colourless 1,2-diiodoethane was washed 2× with water, dried over MgSO₄, filtered over a glass-frit and was used immediately afterwards. Under exclusion of light and under Argon atmosphere a mixture of 2.93 g (19.5 mmol, 1.3 eq) samarium metal powder (approximately 100 mesh) and 4.30 g (15.0 mmol) of colourless 1,2-diiodoethane was suspended in THF (total volume 150 mL). The mixture was heated under reflux whereby a yellow and greenish coloured precipitation was formed. The heating was continued for several hours until the coloured precipitation completely disappeared and a clear, deep-blue solution was obtained. After cooling to room temperature the solution was immediately used for the de-halogenisation of 1-iodo-naphthalene.

### [A] By application of hexamethylphosphorous triamide (HMPA) tablets

Ten tablets containing (in total) 2.44 g (13.6 mmol, 6.8 eq.) HMPA (243 mg/tablet, 1.36 mmol/tablet) were added (within 10 min) to 50 mL of a freshly prepared 0.1 M solution of samarium(II) iodine in THF (5.0 mmol SmI₂, 2.5 eq.) at room temperature. Approximately 10 min later neat 1-iodo-naphthalene (508 mg, 2.0 mmol, 1.0 eq.) was added at room temperature. After 1 h stirring at room temperature, the tablets were removed by filtration and extracted 2× with à 25 mL THF. The solvent was removed by evaporation under atmospheric pressure and the residue was purified by solid phase extraction over silica gel (pentane) furnishing 205 mg (1.60 mmol, 80% yield) of naphthalene 12 (GC-MS: 94% purity, Rₜ=2.8 min). MS (m/e) 128 M⁺. Mp 79-80° C. ¹H NMR δ 7.46 (m, 4H), 7.83 (m, 4H). ¹³C NMR δ 126.3, 128.4, 134.0.

### [B] By conventional preparation without use of tablets

The conventional de-halogenisation procedure was analogously carried out using 2.15 g (12.1 mmol, 6.0 eq.) HMPA. After solid phase extraction over silica gel (pentane) 218 mg (1.7 mmol, 85% yield) of naphthalene 12 was obtained (GC-MS: 94% purity).

### Example 3.13

### 3,4-Difluoro-2′-methoxy-biphenyl 13

### [A] By application of bis(triphenylphosphine)palladium(II) chloride tablets

A suspension of potassium carbonate (465 mg, 3.4 mmol, 6.0 eq.), 3,5-difluorophenylboronic acid (88 mg, 0.56 mmol, 1.0 eq.) and 2-iodoanisole (157 mg 0.67 mmol, 1.2 eq.) and one tablet containing bis(triphenylphosphine)palladium(II) chloride (20 mg, 29 μmol, 5 mol %) in 2.5 mL DMF was gently stirred for 16 hours at 80° C. The tablet was removed by filtration and extracted 2× with à 10 mL ethylacetate. The filtrate was diluted with 100 mL ethylacetate, washed 2× with à 25 mL water and 25 mL brine and dried over MgSO₄. The solvent was removed by evaporation in vacuo and the residue was purified by column chromatography (eluent: neat heptane) furnishing 106 mg (0.48 mmol, 86% yield) of the desired product 13 as colourless oil (GC-MS: 99% purity; Rₜ=5.0 min). MS (m/e) 220 M⁺. ¹H NMR δ 3.82 (s, 3H), 5.88 (t, 1H, J=8.9), 6.1 (d, 1H, J=8.9), 6.15 (t, 1H, J=7.6), 6.19 (d, 2H, J=6.2), 6.41 (d, 1H, J=7.6), 6.48 (t, 1H, J=7.8). ¹³C NMR δ 56.3, 102.9 (t, J_{CF}=25.4), 112.1, 113.2 (dd, J_{1,CF}=19.8, J_{2,CF}=6.0), 121.7, 129.1, 130.4, 131.3, 142.4, 157.0, 163.3 (dd, J_{1,CF}=246.4, J_{2,CF}=12.9). HR MS calcd for C₁₃H₁₀F₂O: m/e 220.06997; Found: m/e 220.06940.

### [B] By application of bis(triphenylphosphine)palladium(II) chloride tablets and microwave

In analogy to the procedure above the synthesis of 13 was carried out in a microwave (10 min/150° C.) with 3.8 mmol 3,5-difluorophenylboronic and one tablet containing bis(triphenylphosphine)palladium(II) chloride (20 mg, 29 μmol, 5 mol %) in 2.5 mL DMF. After purification by column chromatography (heptane) 725 mg (3.3 mmol, 86% yield) of 13 was obtained (GC-MS: 98% purity).

### [C] By application of 2-iodoanisole tablets

The synthesis of 13 was analogously carried out with 3,5-difluorophenylboronic acid (80 mg, 0.5 mmol, 1.0 eq.), bis(triphenylphosphine)palladium(II) chloride (20 mg, 29 μmol, 6 mol %) and one tablet 2-iodoanisole (138 mg, 0.59 mmol, 1.2 eq.) (note: tablets have been stored at 5° C. for 12 months) under gently stirring in 2.5 mL DMF for 16 hours at 80° C. After purification by column chromatography (heptane) 95 mg (0.43 mmol, 85% yield) of 13 was obtained (GC-MS: 98% purity).

### [D] By conventional preparation without use of tablets

The conventional Suzuki procedure was analogously carried out using 600 mg (3.8 mmol, 1.0 eq.) 3,5-difluorophenylboronic acid. After purification by column chromatography (heptane) 728 mg (3.3 mmol, 87% yield) of 13 was obtained (GC-MS: 98% purity).

### Example 3.14

### (2,6-Diisopropyl-phenyl)-phenyl-amine 14

### [A] By application of copper(II) pivaloate tablets

Two tablets containing (in total) 80 mg (0.3 mmol, 15 mol %) copper(II) pivaloate (40 mg/tablet, 0.15 mmol/tablet) were added to a solution of 2,6-diisopropyl-phenyl amine (355 mg, 2.0 mmol, 1.0 eq.) and bis(acetato-O)triphenylbismuth (1.2 g, 2.2 mmol, 1.1 eq) in 20 mL DCM at room temperature. After 16 h of gentle stirring at room temperature, the tablets were removed by filtration and extracted 2× with à 10 mL DCM. The solvent was removed by evaporation in vacuo and the residue was dissolved in 50 mL ethylacetate. The mixture was treated under vigorous stirring with 10 ml of 3 M aqueous HCl (to destroy excess bis(acetato-O)triphenylbismuth and any other possible bismuth intermediates) and subsequently with 20 mL of 3 M aqueous NaOH at 0° C. The organic phase was separated and the aqueous phase was washed 2× with à 25 mL ethylacetate. The combined organic phases were washed 2× with à 10 mL water and 1× with 10 mL brine. The mixture was dried over MgSO₄ and after filtration the solvent was removed by evaporation in vacuo. The residue was purified by solid phase extraction over silica gel (neat pentane) furnishing 440 mg (1.74 mmol, 87% yield) of the desired product 14 as colourless and crystalline solid (GC-MS: 99% purity; Rₜ=6.6 min). MS (m/e) 254 (M⁺+1). ¹H NMR 1.13 (d, 12H, J=7.1), 3.20 (sept, 2H, J=6.8), 5.09 (s broad, 1H), 6.47 (d, 2H, J=8.00), 6.69 (t, 1H, J=7.3), 7.12 (t, 2H, J=7.7), 7.21 (d, 2H, J=8.5), 7.28 (t, 3H, J=7.5). ¹³C NMR δ 24.3, 28.7, 113.5, 118.1, 124.3, 127.7, 129.7, 135.6, 148.0, 148.6.

### [B] By conventional preparation without use of tablets

The conventional aromatic amination procedure was analogously carried out using 60 mg (0.23 mmol, 0.1 eq.) copper(II) pivaloate. After solid phase extraction over silica gel (neat pentane) 456 mg (1.80 mmol, 90% yield) of 14 was obtained (GC-MS: 98% purity).

The following table 3 is an overview of the comparative reactions performed with and without the loaded tablets of the invention.

TABLE 3
Chemical Reactions performed with and without Tablets

| | | Scale/[mmol] | | Isolated Yields % | | |
|---|---|---|---|---|---|---|
| Entry | Reaction^{[a]} | solvent Tablet | +^{[b]} | −^{[c]} | | Lit. |
| 1 | 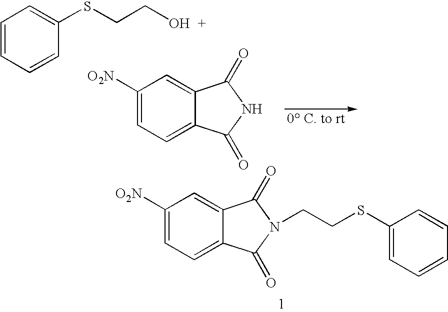 | 1.3 (THF) | DEAD | 85 | 84 | 100 |
| 2 | 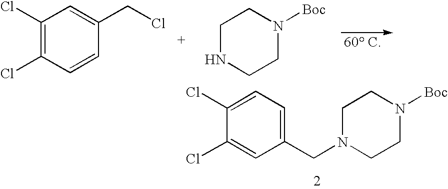 | 1.3 (THF) | 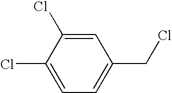 | 76 | 77 | 100 |
| 3 | 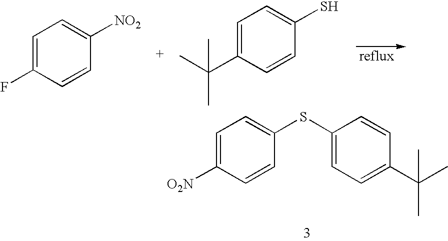 | 15.0 (THF) | K₂CO₃ | 96 | 96 | 99 |
| 4 | 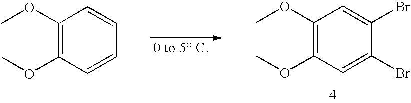 | 50.0 (CCl₄) | Br₂ | 90 | 86 | 83 |
| 5 | 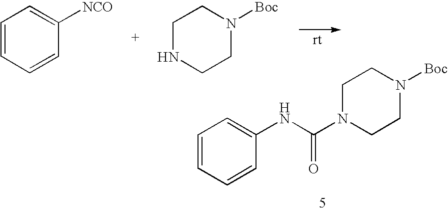 | 1.6 (THF) | 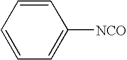 | 88 | 86 | 94 |
| 6 | 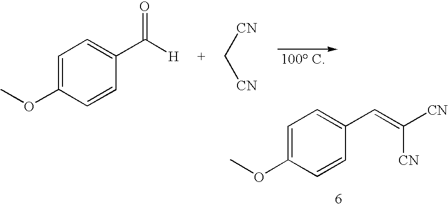 | 10.0 (neat) | ZnCl₂ | 97 | 98 | 97 |
| 7 | 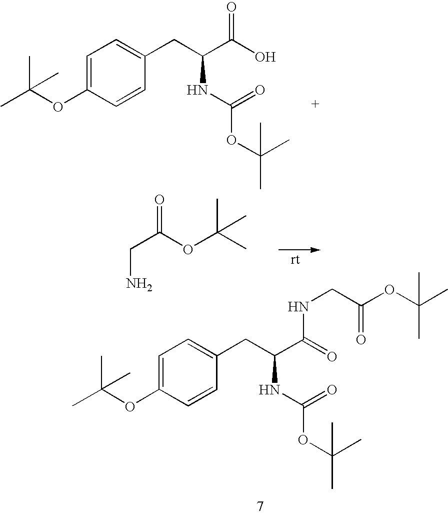 | 1.0 (DCM) | PyBOP | 81 | 80 | [d] |
| 8 | 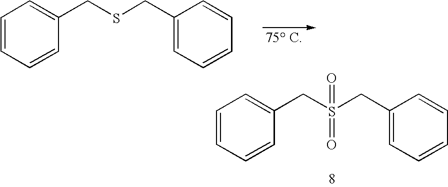 | 16.8 (AcOH) | H₂O₂ | 94 | 89 | 98 |
| 9 | 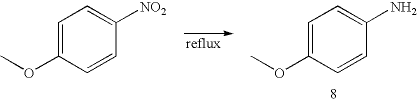 | 5.0 (THF) | SnCl₂*2H₂O | 94 | 94 | 97 |
| 10 | 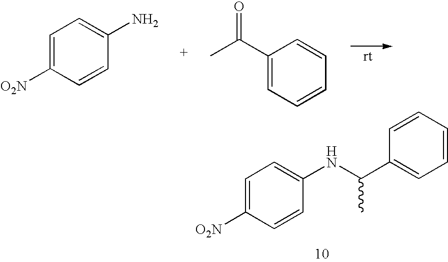 | 1.4 (MeOH) | B₁₀H₁₄ | 76 | 100 | 97 |
| 11 | 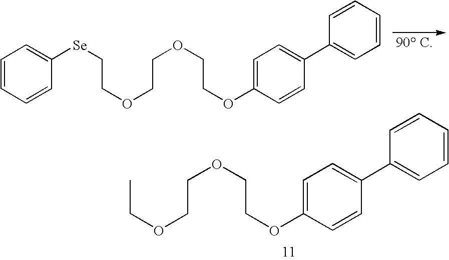 | 0.8 (Toluene) | n-Bu₃SnH | 54 | 82 | 89 |
| 12 | 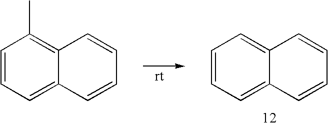 | 2.0 (THF) | HMPA | 80 | 85 | 95 |
| 13 | 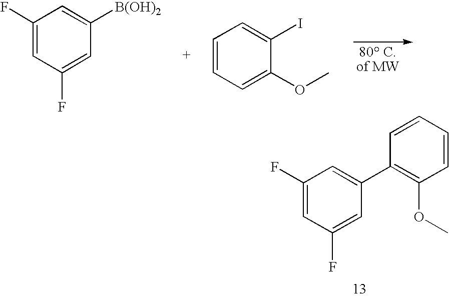 | 0.6 3.8 0.5 (DMF/H₂O) | (Ph₃P)₂PdCl₂(Ph₃P)₂PdCl₂ 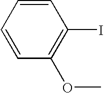 | 86 86 85 | 87 | [d] |
| 14 | 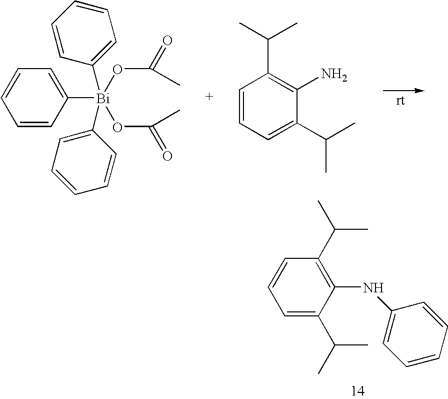 | 2.0 (DCM) | Cu^{II}(piv)₂ | 87 | 90 | 100 |

^{[a]}detailed conditions in Experimental Section;
^{[b]}with tablets;
^{[c]}without tablets;
^{[d]}lit, unknown compound.

1. A reagent delivering article consisting essentially of a porous material, optionally one or more process aiding substances and optionally a solid active substance wherein the reagent delivering article is capable of retaining at least one chemical reagent and releasing said chemical reagent in a solvent.

2. The reagent delivering article according to claim 1, wherein the one or more process aiding substances is a lubricant.

3. The reagent delivering article according to claim 2, wherein the porous material or the lubricant is of non pharmaceutically acceptable quality.

4. The reagent delivering article according to claim 1, wherein the article remains essentially in the original form and does not substantially disintegrate in solution.

5. The reagent delivering article according to claim 1, wherein the porous material is a solid material comprising micropores or mesopores.

6. The reagent delivering article according to claim 1, wherein the reagent delivering article comprises a solid active substance, which solid active substance is inert in respect of the porous material and the optional process aiding substance(s).

7. The reagent delivering article according to claim 6, wherein the solid active substance is selected among a solid reagent, a catalyst, a metal or carrier having a functionalized group attached.

8. The reagent delivering article according to claim 1, wherein the reagent delivering article is essentially formed as a tablet.

9. The reagent delivering article according to claim 1, further provided with an identification means.

10. (canceled)

11. A method of preparing a reagent delivering article according to claim 1 comprising the steps of:
(i) providing a porous material;
(ii) optionally mixing the porous material with one or more process aiding substances;
(iii) optionally mixing the porous material and the optional process aiding substance(s) with a solid active substance;
(iv) processing the admixture into a reagent delivering article;
(v) optionally purifying the reagent delivering article.

12. The method according to claim 11, wherein the processing in step (iv) is a compression of the admixture into tablets using conventional tabletting technology.

13. The method according to claim 11 or 12, wherein step (v) is performed as a washing operation.

14. A loaded reagent delivering article prepared by loading of a reagent delivering article according to claim 1, with at least one chemical reagent.

15. The loaded reagent delivering article according to claim 14, wherein the article further comprises a coating layer.

16. Use of the loaded reagent delivering article according to claim 14 or 15 in solution phase chemistry.

17. The method which comprises delivering at least one reagent to a reaction medium employing reagent delivering article according to claim 1.
